(19) United States
(12) Patent Application Publication
(10) Pub. No.: US 2025/0046893 A1
(43) Pub. Date: Feb. 6, 2025

(54) DEVICE AND METHOD FOR MANUFACTURING DEVICE

(71) Applicant: Panasonic Intellectual Property Management Co., Ltd., Osaka (JP)

(72) Inventors: MAKOTO FUJINO, Osaka (JP); KAZUHIRO MORIOKA, Osaka (JP)

(21) Appl. No.: 18/919,481

(22) Filed: Oct. 18, 2024

Related U.S. Application Data
(63) Continuation of application No. PCT/JP2022/042241, filed on Nov. 14, 2022.

(30) Foreign Application Priority Data
May 18, 2022 (JP) 2022-081466

(51) Int. Cl. H01M 10/48; H01M 10/0525; H01M 10/0562; H01M 10/0585; H01M 50/543

(52) U.S. Cl. CPC H01M 10/482; H01M 10/0562; H01M 10/0585; H01M 50/543; H01M 10/0525

(57) ABSTRACT

A device of the present disclosure includes: a power-generation element including at least one battery cell and having a first main surface, a second main surface opposite to the first main surface, and a side surface connecting the first main surface and the second main surface; a first structure being in contact with the side surface and having a component electrochemically connected to one or more of the at least one battery cell at the side surface; and a second structure having a first member which is located near the first main surface of the power-generation element and which covers the first main surface and the first structure, the first member of the second structure has, at a region covering the first structure, an inclined structure which becomes progressively thicker with distance from the side surface.

### BACKGROUND

### 1. Technical Field

The present disclosure relates to a device including a battery cell and a method for manufacturing the device.

### 2. Description of the Related Art

There are demands for a battery used as a power source for a mobile device or means of mobility to have an especially high energy density. In a case where a battery is used as a power source, the battery is usually not often used in the state of a cell, but typically coexist with a component, such as a circuit and a reference electrode, for controlling the battery properly and safely and/or a component, such as a circuit, for enabling the device to fulfill its functionality with the battery used as a power source.

Also, a three-electrode measurement method is known as a method for measuring the status of a battery. In the three-electrode measurement method, when a battery is actually used, a reference electrode is used as a component so that the electrical characteristics during operation of the battery can be measured, such as the potentials of electrodes such as an anode and a cathode. This enables more accurate tracking of the statuses of the electrodes and more proper control of the battery and in turn enables, for example, maintenance of high-performance characteristics and enhancement of performance such as safety, cycle characteristics, and storage characteristics. International Publication No. WO2021/241121 discloses a structure in which a reference electrode is disposed at a side surface of a battery cell.

### SUMMARY

Usually, additional wiring is needed from a battery to a component, such as a circuit, for controlling the battery or enabling the battery to function, and to provide the wiring, the battery needs to be provided with a terminal. Thus, the wiring and the terminal lower the energy density of the device including the battery and act as a factor in obstructing size reduction of the device including the battery.

Also, especially in a case of a solid-state battery, in order to properly conduct electrochemical measurement using the three-electrode measurement method using a reference electrode as a component, the side surface of the battery and a reference electrode section including the reference electrode need to be in contact with or joined to each other to form a favorable connection state. A favorable connection needs to be formed also at the connection between the battery and the component, such as a circuit, for controlling the battery or enabling the device to function. However, a favorable connection state may not be able to be maintained over a long period of time if any impact, vibration, or the like occurs during practical use.

In this way, a device including a component and a battery is required to have high device reliability by having a favorable connection state between the component and the battery even in a case where the component and the battery are connected at the side surface of the battery for the purpose of conducting the three-electrode measurement method, reducing the device in size, or the like.

In one general aspect, the techniques disclosed here feature a device including: a power-generation element including at least one battery cell and having a first main surface, a second main surface opposite to the first main surface, and a side surface connecting the first main surface and the second main surface; a first structure being in contact with the side surface and having a component electrochemically connected to one or more of the at least one battery cell at the side surface; and a second structure having a first member which is located near the first main surface of the power-generation element and which covers the first main surface and the first structure, in which the first member of the second structure has, at a region covering the first structure, an inclined structure which becomes progressively thicker with distance from the side surface.

According to the present disclosure, device reliability can be enhanced.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view showing a schematic configuration of a device according to Embodiment 1;

FIG. 2 is a flowchart showing an example of a method for manufacturing the device according to Embodiment 1;

FIG. 3A is a sectional view illustrating the method for manufacturing the device according to Embodiment 1;

FIG. 3B is another sectional view illustrating the method for manufacturing the device according to Embodiment 1;

FIG. 4 is a sectional view showing a schematic configuration of a device according to Embodiment 2;

FIG. 5 is a sectional view showing a schematic configuration of a device according to a modification of Embodiment 2;

FIG. 6 is a side view showing a schematic configuration of the device according to the modification of Embodiment 2; and

FIG. 7 is a sectional view showing a schematic configuration of a device according to Embodiment 3.

### DETAILED DESCRIPTIONS

### (Overview of the Present Disclosure)

The following provides a plurality of examples of a device according to the present disclosure.

A device according to a first aspect of the present disclosure includes: a power-generation element including at least one battery cell and having a first main surface, a second main surface opposite to the first main surface, and a side surface connecting the first main surface and the second main surface;
a first structure being in contact with the side surface and having a component electrochemically connected to one or more of the at least one battery cell at the side surface; and
a second structure having a first member which is located near the first main surface of the power-generation element and which covers the first main surface and the first structure,
the first member of the second structure has, at a region covering the first structure, an inclined structure which becomes progressively thicker with distance from the side surface.

Thus, when the device is used with the first main surface and the second main surface being pressurized, force of the pressurization is converted to force with which the inclined structure presses the first structure to the side surface of the power-generation element. This makes it easier for the side surface of the power-generation element and the first structure to stay in contact or stay joined. Thus, a favorable connection state can be maintained at the electrochemical connection between the component and the battery cell even if the device receives impact, vibration, or the like from outside. This allows the functionality of the component to be maintained over a long period of time. Also, the presence of the inclined structure helps prevent the first structure from moving in a direction away from the side surface of the power-generation element, enabling the component and the battery cell to stay connected. Thus, the reliability of the device can be enhanced.

According to a second aspect of the present disclosure, for example, in the device according to the first aspect, a surface of the first member which is covered by the first structure may be inclined relative to the first main surface such that the first structure becomes progressively smaller with distance from the side surface.

Because the surface of the first structure which is covered by the first member is thus inclined in correspondence to the incline of the inclined structure of the first member, force of the pressurization of the first main surface and the second main surface can be converted to force pressing the first structure to the side surface of the power-generation element more effectively. Also, the presence of the inclined structure further helps prevent the first structure from moving in a direction away from the side surface of the power-generation element.

According to a third aspect of the present disclosure, for example, in the device according to the first or second aspect, the at least one battery cell may include an electrode layer, a counter electrode layer, and a first solid electrolyte layer disposed between the electrode layer and the counter electrode layer.

Thus, the reliability can be enhanced for the device including the battery cell which is a solid-state battery.

According to a fourth aspect of the present disclosure, for example, in the device according to the third aspect, the first structure further may have a second solid electrolyte layer which is disposed between the component and the side surface and is in contact with at least one of the electrode layer, the counter electrode layer, or the first solid electrolyte layer at the side surface, and
the component may be a reference electrode.

Thus, electrochemical measurement can be performed stably using the three-electrode measurement method.

According to a fifth aspect of the present disclosure, for example, in the device according to any one of first to third aspects, the first structure may have a terminal that connects the side surface and the component.

Thus, power from the battery cell can be supplied to the component through the terminal.

According to a sixth aspect of the present disclosure, for example, in the device according to any one of the first to fifth aspects, the second structure may contain metal.

Thus, the second structure can be increased in strength, and the second structure can be used for extraction of current from the power-generation element.

According to a seventh aspect of the present disclosure, for example, in the device according to any one of the first to sixth aspects, the second structure may contain resin.

Thus, the second structure can be formed easily. Also, the resin can mitigate stress caused by expansion and contraction of the power-generation element during use.

According to an eighth aspect of the present disclosure, for example, in the device according to any one of the first to seventh aspects, the first structure further may have an insulating member which is located between the component and the first member and which covers the side surface.

Thus, the side surface of the power-generation element and the component can be protected by the insulating member.

According to a ninth aspect of the present disclosure, for example, in the device according to any one of the first to eighth aspects, the at least one battery cell may be a plurality of battery cells, and
the plurality of battery cells may be laminated.

This makes it possible to achieve a device including a power-generation element with high voltage or high capacity.

According to a tenth aspect of the present disclosure, for example, in the device according to the ninth aspect, the component may be electrochemically connected to some of the plurality of battery cells.

This makes it possible to achieve the device including the component that functions in correspondence to some of the battery cells. For example, electric characteristics measurement or the like can be performed for some of the battery cells individually for the plurality of battery cells.

According to an eleventh aspect of the present disclosure, for example, in the device according to any one of the first to tenth aspects, the second structure further may have a second member which is located near the second main surface of the power-generation element and which covers the second main surface and the first structure, and
the second member of the second structure may have, at a region covering the first structure, an inclined structure which becomes progressively thicker with distance from the side surface.

Thus, the inclined structure of the first member and the inclined structure of the second member enable more effective conversion of force of the pressurization of the first main surface and the second main surface into force that presses the first structure against the side surface of the power-generation element. Also, the presence of the inclined structure of the first member and the inclined structure of the second member further helps prevent the first structure from moving in a direction away from the side surface of the power-generation element, enabling the component and battery cell to stay connected.

According to a twelfth aspect of the present disclosure, for example, in the device according to eleventh aspect, a surface of the first structure which is covered by the second member may be inclined relative to the second main surface such that the first structure becomes progressively smaller with distance from the side surface.

Because the surface of the first structure which is covered by the second member is thus inclined in correspondence to the incline of the inclined structure of the second member, force of the pressurization of the first main surface and the second main surface can be converted to force pressing the first structure to the side surface of the power-generation element more effectively. Also, the presence of the inclined structure of the second member further helps prevent the first structure from moving in a direction away from the side surface of the power-generation element.

In addition, an example of a method for manufacturing the device according to the present disclosure is provided below.

A method for manufacturing a device according to a thirteenth aspect of the present disclosure is a method for manufacturing a device including a power-generation element including at least one battery cell and having a first main surface, a second main surface opposite to the first main surface, and a side surface connecting the first main surface and the second main surface and a component electrochemically connected to one or more of the at least one battery cell, the method including:
disposing a first structure including the component in such a manner as to cover the side surface and with the first main surface and the first structure being covered by a first member of a second structure,
pressurizing the power-generation element and the first structure with the second structure interposed in between,
in the pressurizing of the power-generation element and the first structure, using the second structure having the first member having an inclined structure which is formed at a region covering the first structure and which becomes progressively thicker with distance from the side surface, the power-generation element and the first structure are pressurized with the second structure interposed in between to press the first structure against the side surface with the inclined structure.

Thus, force of the pressurization in the pressurizing of the power-generation element and the first structure is converted to force with which the inclined structure of the first member presses the first structure against the side surface of the power-generation element, enabling the first structure to be in contact with or joined to the side surface of the power-generation element sufficiently. As a result, a favorable connection state can be formed at the electrochemical connection between the component and the battery cell. This allows the functionality of the component to be maintained over a long period of time in the device manufactured, and the reliability of the device can be enhanced.

Embodiments are described below in concrete terms with reference to the drawings.

Note that the embodiments described below all provide comprehensive or specific examples. Numerical values, shapes, materials, constituents, the constituents' arrangements, positions, and modes of connection, steps, the order of the steps, and the like provided in the following embodiments are examples and are not provided with an intention to limit the present disclosure. Also, of the constituents in the embodiments below, constituents not described in independent claims are described as optional constituents.

Also, the drawings are schematic views and are not necessarily depicted accurately. Thus, for example, scales and the like are not necessarily consistent throughout the drawings. Also, in the drawings, configurations that are substantially the same are denoted by the same reference numeral, and overlapping descriptions may be omitted or simplified.

Also, a term indicating the relation between elements, such as parallel and orthogonal, a term indicating the shape of an element, such as rectangular or cuboid, and a range of numerical values herein are not expressions representing only the strict meanings, but expressions meaning a substantially equivalent range or that a difference of, for example, a small percentage is included.

Also, the x-axis, the y-axis, and the z-axis used herein and in the drawings represent the three axes of the three-dimensional orthogonal coordinate system. In a case where the plan-view shape of a power-generation element of a battery is a rectangle, the x-axis and the y-axis respectively coincide with a direction parallel to a first side of the rectangle and a direction parallel to a second side orthogonal to the first side. The z-axis coincides with a direction of lamination of a plurality of battery cells included in a power-generation element and lamination of layers of each battery cell.

Also, the “lamination direction” herein coincides with a direction normal to the main surface of each layer of the power-generation element. Also, a “plan view” herein is a view seen in a direction perpendicular to the main surface of the power-generation element, unless otherwise noted in cases such as standalone use. Note that an expression “a plan view of a certain surface” such as “a plan view of a side surface” indicates that the “certain surface” is seen from the front.

Also, terms such as “above” and “under” herein do not refer to an upward direction (upward vertically) and a downward direction (downward vertically) in absolute space recognition, but are used as terms defined by relative positional relations based on the order of layers in a multilayer configuration. Also, the terms “above” and “under” are used not only when two constituents are disposed away from each other with another constituent being present between the two constituents, but also when two constituents are disposed close to each other and in contact. In the following description, the negative side of the z-axis is “under” or “a lower side,” and the positive side of the z-axis is “above” or “an upper side.”

Also, an expression “to cover A” herein means to cover at least part of “A”. More specifically “to cover A” is an expression including not only “to cover A entirely” but “to cover only part of A”. “A” is, for example, a side surface, a main surface, or the like of a predetermined member such as a power-generation element or a layer.

Also, ordinal numbers such as “first” and “second” are used herein to distinguish constituents of the same kind to avoid confusion, not to specify the number or order of the constituents, unless otherwise noted.

### Embodiment 1

First, a device according to Embodiment 1 is described.

### [Device Configuration]

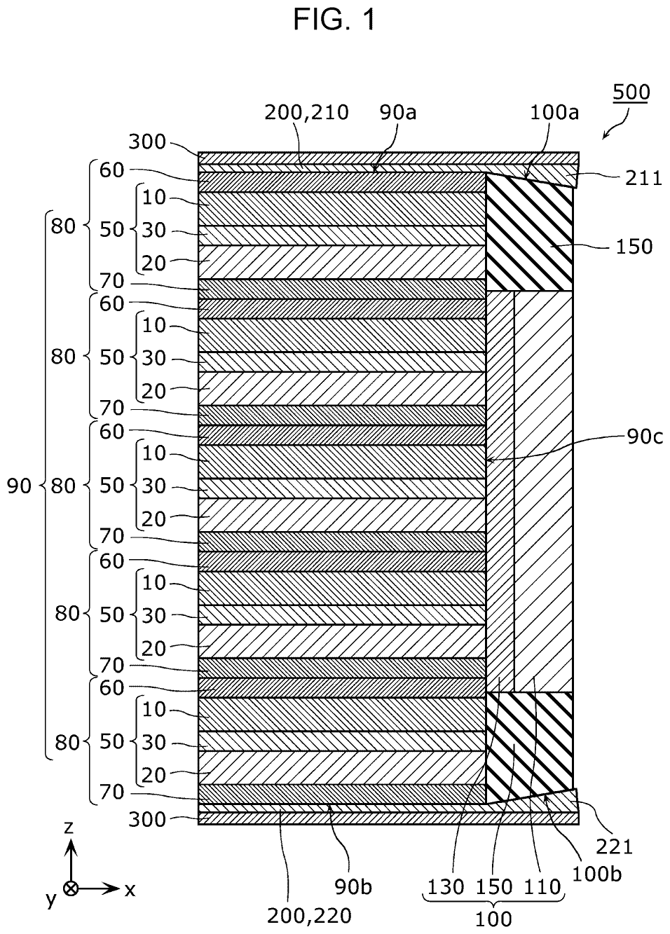

First, the configuration of the device according to the present embodiment is described. FIG. 1 is a sectional view showing a schematic configuration of a device 500 according to the present embodiment.

As shown in FIG. 1, the device 500 according to the present embodiment includes a power-generation element 90 including a plurality of battery cells 80, a first structure 100 having a component 110, a second structure 200 having a first member 210 and a second member 220, and an exterior body 300. FIG. 1 shows a section cut in the z-axis direction at a position passing through the component 110 and the power-generation element 90. The device 500 is a battery module including the component 110 and the power-generation element 90 that functions as a battery. The power-generation element 90 is, for example, a solid-state battery or an all-solid-state battery. The following describes an example where the power-generation element 90 is an all-solid-state battery. The device 500 is, for example, coin-shaped, laminate-shaped, a cylinder-shaped, a square-shaped, or the like.

The constitutes of the device 500 are described in detail below.

### [Power-Generation Element]

The power-generation element 90 has a structure such that the plurality of battery cells 80 are laminated. The shape of the power-generation element 90 is, for example, a cuboid, a polygonal column, a circular column, or the like. Also, the power-generation element 90 has, for example, a flat shape. “Flat” here means that the thickness (i.e., the length in the z-axis-direction) is shorter than the sides of the main surface (i.e., the length in the x-axis direction and the length in the y-axis direction) or the maximum width. Note that in sectional views such as FIG. 1, the thicknesses of the layers are depicted in an exaggerated manner to clarify the layer structure of the power-generation element 90.

The power-generation element 90 has a first main surface 90a, a second main surface 90b, and a side surface 90c. The first main surface 90a and the second main surface 90b are opposite to each other and parallel to each other. The first main surface 90a and the second main surface 90b are arranged in the z-axis direction. In the present embodiment, the first main surface 90a is the uppermost surface of the power-generation element 90, and the second main surface 90b is the lowermost surface of the power-generation element 90.

The side surface 90c connects the first main surface 90a and the second main surface 90b. The side surface 90c is, for example, parallel to the lamination direction (the z-axis direction) in which the layers of the power-generation element 90 are laminated. Also, the side surface 90c extends upright from the sides of the first main surface 90a and the second main surface 90b and is perpendicular to the first main surface 90a and the second main surface 90b. Note that the side surface 90c may be inclined relative to the lamination direction.

The plurality of battery cells 80 are each a battery with a minimum configuration and is also called a unit cell. The plurality of battery cells 80 are laminated like a series circuit (i.e., electrically series-connected). In the present embodiment, all the battery cells 80 that the power-generation element 90 has are electrically series-connected. This makes it possible to achieve a compact, high-voltage power-generation element 90. The power-generation element 90 is a layer-built battery having the plurality of battery cells 80 integrated by adhesion, joining, or the like. Although the power-generation element 90 includes five battery cells 80 in the example shown in FIG. 1, the present disclosure is not limited to this. The power-generation element 90 may have one battery cell 80 or two or more battery cells 80. In other words, the power-generation element 90 includes at least one battery cell 80.

The plurality of battery cells 80 each include an electrode layer 10, a counter electrode layer 20 disposed facing the electrode layer 10, and a first solid electrolyte layer 30 disposed between the electrode layer 10 and the counter electrode layer 20. The plurality of battery cells 80 each further includes an electrode current collector 60 located at the opposite side of the electrode layer 10 from the first solid electrolyte layer 30 and a counter electrode current collector 70 located at the opposite side of the counter electrode layer 20 from the first solid electrolyte layer 30. In other words, the battery cell 80 has a structure such that the electrode current collector 60, the electrode layer 10, the first solid electrolyte layer 30, the counter electrode layer 20, and the counter electrode current collector 70 are laminated in this order.

The electrode layer 10, the first solid electrolyte layer 30, and the counter electrode layer 20 constitute a power generation layer 50, and in the power-generation element 90, the electrode current collector 60 and the counter electrode current collector 70 are disposed between adjacent power generation layers 50, and a plurality of power generation layers 50 are laminated with the electrode current collector 60 and the counter electrode current collector 70 interposed in between. Note that only one of the electrode current collector 60 and the counter electrode current collector 70 may be disposed between adjacent power generation layers 50. Specifically, the electrode layer 10 may be laminated on one of the main surfaces of a single electrode current collector 60 or a single counter electrode current collector 70, and the counter electrode layer 20 may be laminated on the other main surface thereof. In this case, adjacent battery cells 80 share the single electrode current collector 60 or the single counter electrode current collector 70. The single electrode current collector 60 or the single counter electrode current collector 70 in this case is a bipolar current collector which serves as both the electrode current collector 60 and the counter electrode current collector 70.

Note that the electrode layer 10 is one of an anode layer and a cathode layer of the battery cell 80, and the counter electrode layer 20 is the other one of the anode layer and the cathode layer of the battery cell 80. In the example described below, the electrode layer 10 is an anode layer, and the counter electrode layer 20 is a cathode layer.

The configurations of the plurality of battery cells 80 are, for example, substantially the same as one another. In the power-generation element 90, the plurality of battery cells 80 are laminated and arranged along the z-axis such that the layers forming each battery cell 80 may be arranged in the same order as the other ones. In this way, the plurality of battery cells 80 are laminated and electrically series-connected.

In the power-generation element 90, for example, when the power-generation element 90 is seen solely (with constitutes other than the power-generation element 90 removed), the end portions of the electrode current collectors 60, the electrode layers 10, the first solid electrolyte layers 30, the counter electrode layers 20, and the counter electrode current collectors 70 of the battery cell 80 are exposed at the side surface 90c. This makes it possible to form electrochemical connection between the component 110 and the battery cells 80. The constituents of the battery cells 80 that are uninvolved in the electrochemical connection to the component 110 do not have to be exposed.

Note that in the power-generation element 90, the plurality of battery cells 80 may be laminated like a parallel circuit (i.e., electrically parallel-connected). In this case, the plurality of battery cells 80 are laminated so that the same electrodes of adjacent battery cells 80 are electrically connected to each other. In other words, the plurality of battery cells 80 are arranged and laminated along the z-axis with the order of arrangement of the layers constituting each battery cell 80 being changed alternately. This makes it possible to achieve a compact, high-voltage power-generation element 90.

The electrode layer 10 is located between the electrode current collector 60 and the first solid electrolyte layer 30 and is in contact with the electrode current collector 60 and the first solid electrolyte layer 30.

The electrode layer 10 includes at least an anode active material. In addition to the anode active material, an anode mixture may be used as needed as a material for the electrode layer 10, the anode mixture including at least one of a solid electrolyte, a conductive aid, or a binder material.

As the anode active material, a publicly-known material that can occlude and release (insert and deinsert or dissolve and deposit) metallic ions such as lithium ions, sodium ions, magnesium ions, potassium ions, calcium ions, or copper ions may be used.

Examples of the anode active material include transition metal oxide containing lithium, transition metal oxide not containing lithium, transition metal fluoride, a polyanion material, a fluorinated polyanion material, transition metal sulfide, transition metal oxyfluoride, transition metal oxysulfide, and transition metal oxynitride. Using transition metal oxide containing lithium for the anode active material can lower the manufacturing cost of the power-generation element 90 and raise the average discharge voltage of the power-generation element 90.

As the anode active material, in a case of a material capable of deinsertion and insertion of lithium ions, for example, lithium cobalt composite oxide (LCO), lithium nickel composite oxide (LNO), lithium manganese composite oxide (LMO), lithium-manganese-nickel composite oxide (LMNO), lithium-manganese-cobalt composite oxide (LMCO), lithium-nickel-cobalt composite oxide (LNCO), lithium-nickel-manganese-cobalt composite oxide (LNMCO), or the like is used. Specific examples of the anode active material include LiCoO₂, LiMn₂O₄, Li₂NiMn₃O₈, LiVO₂, LiCrO₂, LiFePO₄, LiCoPO₄, LiNiO₂, LiNi_{1/3}CO_{1/3}Mn_{1/3}O₂, LiNiₓMn_{y}Al₂O₂, LiNiₓCo_{y}Mn_{z}, and LiNiₓCo_{y}Al_{z}.

As the solid electrolyte, a publicly-known material that conducts, e.g., protons or metallic ions such as lithium ions, sodium ions, magnesium ions, potassium ions, calcium ions, copper ions, or silver ions may be used. A solid electrolyte material such as, for example, a sulfide solid electrolyte, a halogen-based solid electrolyte, an oxide solid electrolyte, or a polymeric solid electrolyte is used as the solid electrolyte.

As the sulfide solid electrolyte, in a case of a material capable of conducting lithium ions, for example, a synthetic product (Li₂S—P₂S₅) of lithium sulfide (Li₂S) and phosphorus pentasulfide (P₂S₅) is used. Also, examples of the sulfide solid electrolyte include sulfides such as Li₂S—P₂S₅, Li₂S—P₂S₅—LiBH₄, Li₂P₃S₁₁, Li₂S—SiS₂, Li₂S—SiS₂—Li₃PO₄, Li₂S—SiS₂—Li₄SiO₄, Li₂S—B₂S₃, Li₂S—GeS₂, Li₆PS₅Cl, and LiSiPSCl and sulfides containing Li₃N or Li₃N(H). Also, as the sulfide solid electrolyte, sulfide having at least one of Li₃N, LiCl, LiBr, LiI, Li₃PO₄, or Li₄SiO₄ added to the above-listed sulfide as an additive may be used. Also, other specific examples of the sulfide solid electrolyte include Li₁₀GeP₂S₁₂ (LGPS) and Na₃Zr₂ (SiO₄)₂PO₄ (NASICON).

As the oxide solid electrolyte, in a case of a material capable of conducting lithium ions, for example, Li₂La₃Zr₂O₁₂ (LLZ), Li_{1.3}Al_{0.3}Ti_{1.7}(PO₄)₃ (LATP), (La, Li) TiO₃ (LLTO), or the like is used.

The halogen-based solid electrolyte is a solid electrolyte containing a halide. A halide is a compound of, for example, Li, M′, and X′. M′ is at least one element selected from the group consisting of metallic and metalloid elements except for Li. X′ is at least one element selected from the group consisting of F, Cl, Br, and I. “Metallic elements” are all the elements belonging to Groups 1 to 12 in the periodic table (excluding hydrogen) and all the elements belonging to Groups 13 to 16 in the periodic table (excluding B, Si, Ge, As, Sb, Te, C, N, P, O, S, and Se). The “metalloid elements” are B, Si, Ge, As, Sb, and Te. For example, M′ may include Y (yttrium). Examples of the halide containing Y include Li₃YCl₆ and Li₃YBr₆.

Other examples of halide include Li₂MgX′₄, Li₂FeX′₄, Li(Al,Ga,In)X′₄, Li₃(Al,Ga,In)X′₆, LiOX′, and LiX′. Specifically, examples of the halide include Li₃InBr₆, Li₃InCl₆, Li₂FeCl₄, Li₂CrCl₄, Li₃OCl, and LiI.

There is no particular limitation as to the polymeric solid electrolyte as long as it is a solid electrolyte containing an ion-conductive polymer material, and examples of the ion-conductive polymer material include polyether, polyether derivative, polyester, and polyimine.

Also, as the solid electrolyte, other than the solid electrolyte materials listed above, a thin-film solid electrolyte material such as nitrogen-doped lithium phosphate (LiPON) may be used.

In the electrode layer 10, the ratio of the volume of the anode active material to the sum of the volume of the anode active material and the volume of the solid electrolyte is, for example, 30% or higher and 95% or lower. Also, the ratio of the volume of the solid electrolyte to the sum of the volume of the anode active material and the volume of the solid electrolyte is, for example, 5% or higher and 70% or lower. Such volume ratios of the amount of the anode active material and the amount of the solid electrolyte make it easier for the power-generation element 90 to have sufficient energy density and easier for the power-generation element 90 to operate at a high output level.

As the binder material, a binder similar to one used in a typical solid-state battery can be used. Examples of the binder material include polyvinylidene fluoride, polytetrafluoroethylene, polyethylene, polypropylene, aramid resin, polyamide, polyimide, polyamide imide, polyacrylonitrile, polyallylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene-butadiene rubber, carboxymethyl cellulose, polyaniline, polythiophene styrene butadiene rubber, and polyacrylate. Also, as the binder material, a copolymer of two or more materials selected from tetrafluoroethylene, hexafluoroethylene, hexafluoropropylene, perfluoro alkyl vinyl ether, vinylidene fluoride, chlorotrifluoroethylene, ethylene, propylene, pentafluoropropylene, fluoromethyl vinyl ether, acrylic acid, and hexadiene may be used.

Examples of the conductive aid include graphite such as natural graphite and artificial graphite, carbon black such as acetylene black, furnace black, and Ketjenblack (registered trademark), conductive fibers such as VGCF, carbon nanotubes, carbon nanofibers, fullerenes, carbon fibers, and metal fibers, metal powder such as fluorocarbon and aluminum power, conductive whiskers such as zinc oxide whiskers and potassium titanate whiskers, conductive metal oxides such as titanium oxide, and conductive polymer compounds such as polyaniline, polypyrrole, and polythiophene.

The conductive aid is, for example, needle-shaped, scale-shaped, sphere-shaped, or oval-sphere shaped. The conductive aid may be granular.

The thickness of the electrode layer 10 is, for example, 10 μm or greater and 500 μm or smaller. The thickness of the electrode layer 10 being in such a range makes it easier for the power-generation element 90 to have sufficient energy density and easier for the power-generation element 90 to operate at a high output level. Note that the thickness of each constituent of the power-generation element 90 herein is the length of the constituent in the lamination direction.

An example method for forming the electrode layer 10 is to uniaxially compact a powdered anode mixture. Also, the electrode layer 10 may be fabricated by drying a paste-form paint applied to a base, the first solid electrolyte layer 30, the electrode current collector 60, or the like, the paint being the anode mixture and a solvent kneaded together.

The counter electrode layer 20 is located between the counter electrode current collector 70 and the first solid electrolyte layer 30 and is in contact with the counter electrode current collector 70 and the first solid electrolyte layer 30.

The counter electrode layer 20 contains at least a cathode active material. In addition to the cathode active material, a cathode mixture may be used as needed as a material for the counter electrode layer 20, the cathode mixture including at least one of a solid electrolyte, a conductive aid, or a binder material.

As the cathode active material, a publicly-known material that can occlude and release (insert and deinsert or dissolve and deposit) metallic ions such as lithium ions, sodium ions, magnesium ions, potassium ions, calcium ions, or copper ions may be used. Examples of the cathode material include metal materials, carbon materials, oxides, nitrides, tin compounds, and silicon compounds.

As the cathode active material, in a case of a material capable of deinsertion and insertion of lithium ions, for example, a carbon material such as natural graphite, artificial graphite, graphite carbon fiber, or resin-baked carbon, metallic lithium, a lithium alloy, an oxide of lithium and a transition metal element, or the like is used. Examples of metal used in the lithium alloy include indium, aluminum, silicon, germanium, tin, and zinc. Specific examples of the oxide of lithium and a transition metal element include Li₄Ti₅O₁₂ and LiₓSiO.

As the solid electrolyte for the counter electrode layer 20, the solid electrolyte materials listed above may be used. Also, as the conductive aid for the counter electrode layer 20, the conductive aids listed above may be used. Also, as the binder material for the counter electrode layer 20, the binder materials listed above may be used.

In the counter electrode layer 20, the ratio of the volume of the cathode active material to the sum of the volume of the cathode active material and the volume of the solid electrolyte is, for example, 30% or higher and 95% or lower. Also, the ratio of the volume of the solid electrolyte to the sum of the volume of the cathode active material and the volume of the solid electrolyte is, for example, 5% or higher and 70% or lower. Such volume ratios of the amount of the cathode active material particles and the amount of the solid electrolyte make it easier for the power-generation element 90 to have sufficient energy density and easier for the power-generation element 90 to operate at a high output level.

The thickness of the counter electrode layer 20 is, for example, 10 μm or greater and 500 μm or smaller. The thickness of the counter electrode layer 20 being in such a range makes it easier for the power-generation element 90 to have sufficient energy density and easier for the power-generation element 90 to operate at a high output level.

An example method for forming the counter electrode layer 20 is to uniaxially compact a powdered cathode mixture. Also, the counter electrode layer 20 may be fabricated by drying a paste-form paint applied to a base, the first solid electrolyte layer 30, the counter electrode current collector 70, or the like, the paint being the cathode mixture and a solvent kneaded together.

The first solid electrolyte layer 30 is located between the electrode layer 10 and the counter electrode layer 20 and is in contact with the electrode layer 10 and the counter electrode layer 20.

The first solid electrolyte layer 30 is conductive for metallic ions such as lithium ions, sodium ions, magnesium ions, potassium ions, calcium ions, or copper ions. The first solid electrolyte layer 30 may be conductive for lithium ions.

The first solid electrolyte layer 30 includes at least a solid electrolyte and may include a binder material as needed. Also, the first solid electrolyte layer 30 may include a solid electrolyte conductive for lithium ions.

The solid electrolyte materials listed above may be used as the solid electrolyte material for the first solid electrolyte layer 30. A single kind of solid electrolyte or two or more kinds of solid electrolyte may be used for the first solid electrolyte layer 30. Also, as the binder material for the first solid electrolyte layer 30, the binder materials listed above may be used.

The thickness of the first solid electrolyte layer 30 is, for example, 0.1 μm or greater and 1000 μm or smaller. From the perspective of improving the energy density of the power-generation element 90, the thickness of the first solid electrolyte layer 30 may be 0.1 μm or greater and 50 μm or smaller.

An example method for forming the first solid electrolyte layer 30 is to uniaxially compact a powdered material contained in the first solid electrolyte layer 30. Also, the first solid electrolyte layer 30 may be fabricated by drying a paste-form paint to a base, the electrode layer 10, the counter electrode layer 20, or the like, the paste being the material contained in the first solid electrolyte layer 30 and a solvent kneaded together.

The side surface of the electrode layer 10, the side surface of the counter electrode layer 20, and the side surface of the first solid electrolyte layer 30 are flush, forming the side surface of the power generation layer 50. Note that the side surface of the electrode layer 10, the side surface of the counter electrode layer 20, and the side surface of the first solid electrolyte layer 30 do not have to be flush. For example, the first solid electrolyte layer 30 may cover the side surfaces of the electrode layer 10 and the counter electrode layer 20 such that the side surface of the power generation layer 50 is formed only by the side surface of the first solid electrolyte layer 30.

The electrode current collector 60 is located on the opposite side of the electrode layer 10 from the first solid electrolyte layer 30 and is in contact with the electrode layer 10. Also, the counter electrode current collector 70 is located on the opposite side of the counter electrode layer 20 from the first solid electrolyte layer 30 and is in contact with the counter electrode layer 20.

Examples of materials for the electrode current collector 60 and the counter electrode current collector 70 include highly-conductive metal materials such as copper, aluminum, nickel, iron, stainless steel, platinum, and gold, alloys of two or more of these metal materials, and materials plated with any of these metal materials. The electrode current collector 60 and the counter electrode current collector 70 may be formed of the same material or different materials.

The shapes of the electrode current collector 60 and the counter electrode current collector 70 are set according to, e.g., the shape of the power-generation element 90 and are therefore not limited to any particular shapes. The electrode current collector 60 and the counter electrode current collector 70 are, for example, bar-shaped, plate-shaped, sheet-shaped, foil-shaped, mesh-shaped, or the like.

The thicknesses of the electrode current collector 60 and the counter electrode current collector 70 are, for example, 1 μm or greater and 10 mm or smaller. The thicknesses of the electrode current collector 60 and the counter electrode current collector 70 may be 1 μm or greater and 50 μm or smaller. Also, depending on the shape of the device 500, the thicknesses of the electrode current collector 60 and the counter electrode current collector 70 may be 10 mm or greater.

The plan-view shape of each of the electrode layer 10, the counter electrode layer 20, the first solid electrolyte layer 30, the electrode current collector 60, and the counter electrode current collector 70 is, for example, rectangular, circular, polygonal, or the like. When seen in the z-axis direction, for example, the outer edges of the electrode layer 10, the counter electrode layer 20, the first solid electrolyte layer 30, the electrode current collector 60, and the counter electrode current collector 70 coincide. The side surfaces of the plurality of battery cells 80 constitute the side surface 90c of the power-generation element 90 and are, for example, flush. Note that when seen in the z-axis direction, the outer edges of the electrode layer 10, the counter electrode layer 20, the first solid electrolyte layer 30, the electrode current collector 60 and the counter electrode current collector 70 do not have to coincide.

### [First Structure]

The first structure 100 has the component 110, a contact surface part 130, and an insulating member 150. The first structure 100 is provided in such a manner to cover the side surface 90c of the power-generation element 90. If the power-generation element 90 is cuboid, the first structure 100 covers, for example, only one side surface 90c out of the four side surfaces of the power-generation element 90. For example, the first structure 100 covers the side surface 90c of the power-generation element 90 from an end portion of the side surface 90c on the first main surface 90a side to an end portion thereof on the second main surface 90b side. Also, the first structure 100 is in contact with the side surface 90c from the end portion of the side surface 90c on the first main surface 90a side to the end portion thereof on the second main surface 90b side. Note that depending on the shape of the second structure 200, the first structure 100 does not have to cover the side surface 90c from the end portion of the side surface 90c on the first main surface 90a to the end portion thereof on the second main surface 90b as long as the first structure 100 is in contact with the first member 210 and the second member 220 of the second structure 200.

The first structure 100 does not protrude outward beyond both ends of the power-generation element 90 in the lamination direction of the power-generation element 90 (i.e., the z-axis direction). In the present embodiment, both ends of the first structure 100 in the lamination direction are formed by the insulating member 150, and the insulating member 150 does not protrude outward beyond both ends of the power-generation element 90 in the lamination direction of the power-generation element 90. In the lamination direction of the power-generation element 90, the maximum length of the first structure 100 is equal to or smaller than that of the power-generation element 90. Thus, even if the power-generation element 90 is pressurized in the lamination direction during use in order to improve its battery characteristics, the first structure 100 does not easily interfere with the pressurization of the power-generation element 90, and the pressurized state of the power-generation element 90 is maintained more easily. In the present embodiment, in the lamination direction of the power-generation element 90, the maximum length of the first structure 100 is the same as that of the power-generation element 90.

The first structure 100 is sandwiched by the second structure 200 from both sides in the z-axis direction and is in contact with the second structure 200. Specifically, a surface 100a of the first structure 100 on the first main surface 90a in the lamination direction of the power-generation element 90 is covered by the first member 210 of the second structure 200 and is in contact with the first member 210. Also, a surface 100b of the first structure 100 on the second main surface 90b in the lamination direction of the power-generation element 90 is covered by the second member 220 of the second structure 200 and is in contact with the second member 220.

The surface 100a of the first structure 100 which is covered by the first member 210 is inclined relative to the first main surface 90a such that the first structure 100 becomes progressively smaller with distance from the side surface 90c. In other words, the surface 100a covered by the first member 210 is inclined relative to the first main surface 90a such that the angle formed between the surface 100a and the side surface 90c is smaller. Also, the surface 100b of the first structure 100 which is covered by the second member 220 is inclined relative to the second main surface 90b such that the first structure 100 becomes progressively smaller with distance from the side surface 90c. In other words, the surface 100b covered by the second member 220 is inclined relative to the second main surface 90b such that the angle formed between the surface 100b and the side surface 90c is smaller. Thus, the length of the first structure 100 in the z-axis direction becomes progressively shorter with distance from the side surface 90c. In a case where the first structure 100 is cut in the z-axis direction to obtain a surface perpendicular to the side surface 90c, the sectional shape of the first structure 100 is, for example, a trapezoid having two sides parallel to the z-axis, and the length of the trapezoid in the z-axis direction becomes progressively shorter with distance from the side surface 90c. Note that at least one of the surface 100a or the surface 100b does not have to be inclined.

The component 110 is disposed facing the side surface 90c. The component 110 is, at the side surface 90c, electrochemically connected to one or more of the plurality of battery cells 80. To be electrochemically connected herein means to be connected electron-conductively or ion-conductively. There is no particular limitation as to the number of battery cells 80 electrochemically connected to the component 110. The component 110 may be electrochemically connected to one of the plurality of battery cells 80 or two or more of the plurality of battery cells 80. In a case where the component 110 is electrochemically connected to two or more battery cells 80, the component 110 may be electrochemically connected to each of the two or more battery cells 80, or the component 110 may be electrochemically connected to the two or more battery cells 80 so that voltage can be extracted from the two or more battery cells 80 series-connected. Also, although electrochemically connected to some of the plurality of battery cells 80 in the example shown in FIG. 1, the component 110 may be electrochemically connected to all of the plurality of battery cells 80. For example, the component 110 is electrochemically connected to one or more battery cells 80 with the contact surface part 130 interposed in between. Although the first structure 100 has one component 110 and one contact surface part 130 in the example shown in FIG. 1, at least one of the component 110 or the contact surface part 130 may include a plurality of them.

The component 110 is not a member for passing current, such as a terminal or wiring, but a component that exchanges gives and receives electrons or ions to and from the battery cell 80 and is caused to function by the electrons or ions thus given and received. Specifically, the component 110 is, for example, a reference electrode or an electric circuit. Examples of the electric circuit include a battery information measurement circuit that measures battery-related information, a battery control circuit that controls the operation of the battery, and a battery management circuit used to manage the battery.

The battery information measurement circuit is a circuit that measures, for example, at least one of the following pieces of information on one or more battery cells 80 connected to the component 110: a history of charging and discharging, summation of power amount, a charging/discharge cycle count, voltage, state of charge (SOC), deterioration, or abnormality.

The battery control circuit is, for example, an overcharge protection circuit or an overdischarge protection circuit for the one or more battery cells 80. The battery control circuit may be a circuit that controls the amount of current flowing from the one or more battery cells 80. Also, in a case where the component 110 is connected to a plurality of battery cells 80, the battery control circuit may be a cell balancing circuit that adjusts the charging levels of the plurality of battery cells 80. The cell balancing circuit may be, for example, an active cell balancing circuit that passes current from the battery cell 80 with a higher charging level to the battery cell with a lower charging level among the plurality of battery cells 80, or may be a passive cell balancing circuit that discharges current to the outside of the system from the battery cell 80 with a high charging level among the plurality of battery cells 80.

The battery management circuit is, for example, a battery ID information retention circuit, a circuit for global positioning system (GPS) or a circuit for radio frequency identifier (RFID).

The contact surface part 130 is disposed between the component 110 and the side surface 90c. The contact surface part 130 is in contact with the component 110 and the side surface 90c. The contact surface part 130 is a member conductive for electrons or ions. The contact surface part 130 may be entirely or partly formed of a material conductive for electrons or ions. For example, the contact surface part 130 is, at the side surface 90c, in contact with one or more battery cells 80 and electrochemically connected to the one or more battery cells 80.

In a case where the component 110 is a reference electrode, the contact surface part 130 is conductive for ions, and for example, the component 110 is in contact with the power generation layer 50 of the battery cell 80 and is connected to the battery cell 80 ion-conductively. In a case where the component 110 is an electric circuit, the contact surface part 130 is conductive for electrons, and for example, the component 110 is in contact with the electrode current collector 60 and the counter electrode current collector 70 of the battery cell 80 and is connected to one or more battery cells 80 electron-conductively. Note that the first structure 100 does not have to have the contact surface part 130, and the component 110 may be electrochemically connected to one or more battery cells 80 directly at the side surface 90c.

The insulating member 150 is located between the component 110 and the first member 210 and between the component 110 and the second member 220. The insulating member 150 is also located between the contact surface part 130 and the first member 210 and between the contact surface part 130 and the second member 220. For example, the insulating member 150 covers the side surface 90c and is in contact with the side surface 90c. The insulating member 150 may be disposed in such a manner as to sandwich or surround the component 110 and the contact surface part 130 in a plan view of the side surface 90c. In the present embodiment, the surfaces 100a and 100b of the first structure 100 are a surface of the insulating member 150 on the first member 210 side and a surface of the insulating member 150 on the second member 220 side, respectively. The insulating member 150 is, for example, in contact with the component 110, the contact surface part 130, the first member 210, and the second member 220.

The insulating member 150 is formed using an insulating material with an electrically insulating property. For example, the insulating member 150 is formed using resin as the insulating material. There is no particular limitation as to the type of the resin. Note that an inorganic material may be used as the insulating material. A usable insulating material is selected based on various properties such as flexibility, gas barrier properties, impact resistance, and heat resistance. The insulating member 150 may be formed of a single ingredient or a plurality of ingredients.

Because the first structure 100 has such an insulating member 150, the side surface 90c of the power-generation element 90 and the component 110 can be protected. Also, because the insulating member 150 is formed around the component 110, processing the shape of the insulating member 150 determines the shape of the first structure 100, which makes it easier to form the first structure 100 in a desired shape.

### [Second Structure]

For example, the second structure 200 is disposed in such a manner as to cover the power-generation element 90 and the first structure 100 collectively from both sides in the z-axis direction. The second structure 200 has the first member 210 and the second member 220 which is disposed facing the first member 210. The first member 210 and the second member 220 are members in the shape of, for example, a plate, a sheet, or a foil.

The first member 210 is located on the first main surface 90a side of the power-generation element 90. The first member 210 covers the first main surface 90a and the first structure 100 and is in contact with the first main surface 90a and the first structure 100. A different member such as an adhesive member may be provided between the first member 210 and the first main surface 90a and between the first member 210 and the first structure 100. For example, the first member 210 may be joined to the first main surface 90a and the first structure 100 by a conductive or insulating adhesive or the like.

The first member 210 has an inclined structure 211 at a region covering the first structure 100 outside of the side surface 90c of the power-generation element 90, the inclined structure 211 increasing in thickness (the length in the z-axis direction) with distance from the side surface 90c. The inclined structure 211 covers the surface 100a of the first structure 100 on the first member 210 side and is in contact with the surface 100a. Part of the inclined structure 211 overlaps with the side surface 90c and the first structure 100 in a plan view of the side surface 90c. In a direction perpendicular to the side surface 90c (the x-axis direction), the inclined structure 211 is, for example, longer than the first structure 100. The rate at which the inclined structure 211 increases in thickness with distance from the side surface 90c and the rate at which the first structure 100 decreases in length in the z-axis direction with distance from the side surface 90c due to the incline of the surface 100a are, for example, the same. Also, at the region covering the first main surface 90a, the first member 210 is, for example, uniform in thickness.

The second member 220 is located on the second main surface 90b side of the power-generation element 90. The second member 220 covers the second main surface 90b and the first structure 100 and is in contact with the second main surface 90b and the first structure 100. Another member such as an adhesive member may be provided between the second member 220 and the second main surface 90b and between the second member 220 and the first structure 100. For example, the second member 220 may be joined to the second main surface 90b and the first structure 100 by a conductive or insulating adhesive or the like.

The second member 220 has an inclined structure 221 at a region covering the first structure 100 outside of the side surface 90c of the power-generation element 90, the inclined structure 221 increasing in thickness (the length in the z-axis direction) with distance from the side surface 90c. The inclined structure 221 covers the surface 100b of the first structure 100 on the second member 220 side and is in contact with the surface 100b. Part of the inclined structure 221 overlaps with the side surface 90c and the first structure 100 in a plan view of the side surface 90c. In a direction perpendicular to the side surface 90c (the x-axis direction), the inclined structure 221 is, for example, longer than the first structure 100. The rate at which the inclined structure 221 increases in thickness with distance from the side surface 90c and the rate at which the first structure 100 decreases in length in the z-axis direction with distance from the side surface 90c due to the incline of the surface 100b are, for example, the same. Also, at the region covering the second main surface 90b, the second member 220 is, for example, uniform in thickness.

The first member 210 and the second member 220 are, for example, separately formed, but the first member 210 and the second member 220 may be connected at a certain location (not shown).

The second structure 200 contains, for example, metal. This enables the second structure 200 to be used for extracting current from the power-generation element 90. It can also increase the strength of the second structure 200. The second structure 200 is, for example, formed entirely of metal. In this case, for example, the inclined structure 211 and the inclined structure 221 are formed by metalworking, plating, or the like. Also, the second structure 200 may be formed partly of metal. The second structure 200 may contain, for example, resin. In this case, for example, the inclined structure 211 and the inclined structure 221 may be formed by applying resin to a metal foil while giving it thickness distribution. Also, the second structure 200 may be formed entirely of resin. When the second structure 200 contains resin, the second structure 200 can be easily formed into an intended shape. Also, the resin can mitigate stress caused by expansion and contraction of the power-generation element 90 during use.

Note that the second structure 200 may have only one of the first member 210 and the second member 220.

### [Exterior Body]

The exterior body 300 houses the power-generation element 90, the first structure 100, and the second structure 200. For example, the exterior body 300 seals the power-generation element 90, the first structure 100, and the second structure 200. This makes it easier to maintain the contact between the power-generation element 90 and the first structure 100.

A publicly-known exterior body for batteries may be used for the exterior body 300. The exterior body 300 is formed of, for example, a laminated film, a metal can, or the like. The laminated film is, for example, a film with a multi-layer structure of resin such as polyethylene resin or polypropylene resin and metal such as aluminum. The laminated film has, for example, a three-layer structure in which a resin layer, a metal layer, and a resin layer are laminated in this order. By being formed of a laminated film, the exterior body 300 can be lightweight, flexible, and provide favorable barrier properties against air and water.

Also, the power-generation element 90, the first structure 100, and the second structure 200 may be sealed by the exterior body 300 under reduced pressure. This allows the power-generation element 90, the first structure 100, and the second structure 200 to stay in a pressurized state, which enhances the battery performance of the power-generation element 90 and causes the first structure 100 to be pressed against the side surface 90c of the power-generation element 90 at all times.

Note that the device 500 does not have to have the exterior body 300. Also, the power-generation element 90, the first structure 100, and the second structure 200 may be sealed not by the exterior body 300 but by a sealing member formed of a resin material.

### [Method for Manufacturing the Device]

Next, a method for manufacturing the device 500 according to the present embodiment is described.

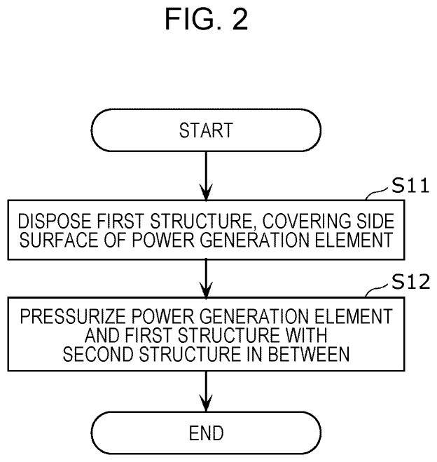

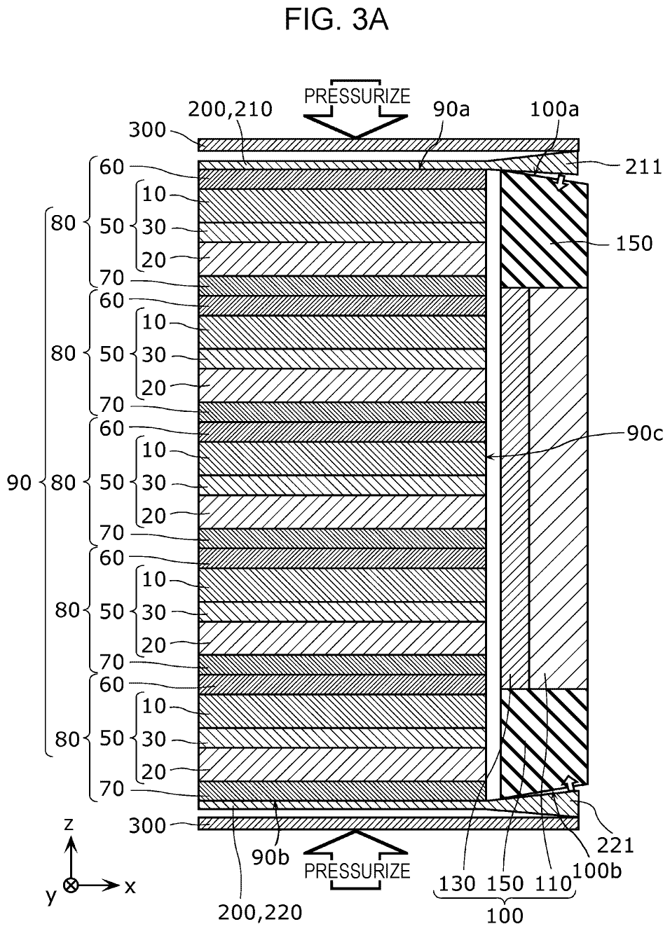

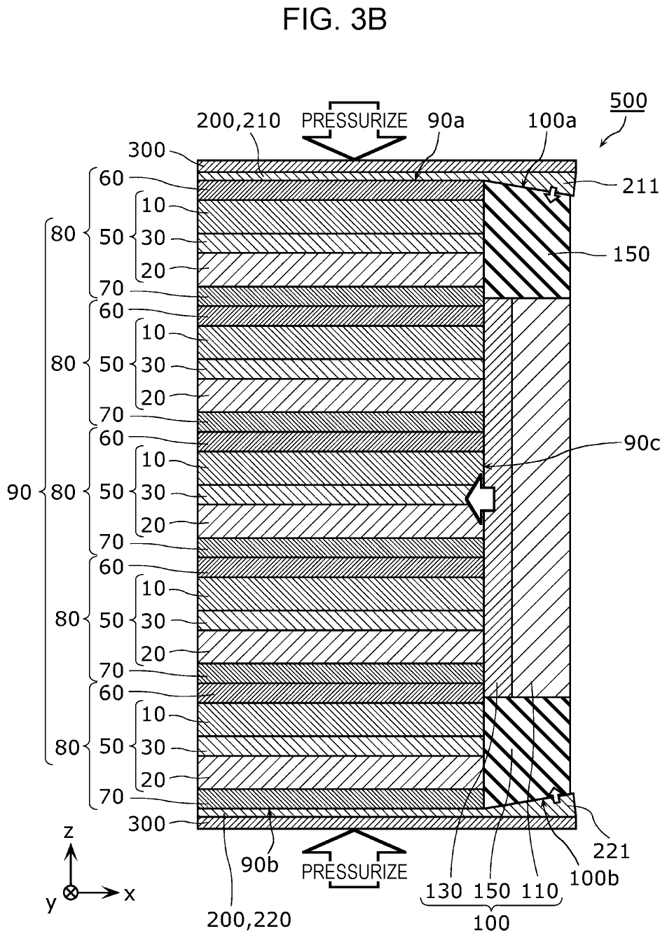

FIG. 2 is a flowchart showing an example method for manufacturing the device 500 according to the present embodiment. FIGS. 3A and 3B are sectional views illustrating the method for manufacturing the device 500 according to the present embodiment.

As shown in FIG. 2, in the method for manufacturing the device 500, first, the first structure 100 is disposed in such a manner as to cover the side surface 90c of the power-generation element 90 (Step S11). For example, as shown in FIG. 3A, the first structure 100 including the component 110 is disposed in such a manner as to cover the side surface 90c from the end portion of the side surface 90c on the first main surface 90a to the end portion thereof on the second main surface 90b side. Although the side surface 90c and the first structure 100 are spaced away from each other in the example shown in FIG. 3A, the side surface 90c and the first structure 100 may be in contact with each other.

The power-generation element 90 used in Step S11 is manufactured using, for example, a method similar to one used in typical battery manufacturing. For example, first, the power generation layer 50 is fabricated through compression molding which involves sequentially pressurizing powder of a material forming the electrode layer 10, powder of a material forming the first solid electrolyte layer 30, and powder of a material forming the counter electrode layer 20. The power generation layer 50 may be fabricated by applying slurries of materials for the respective layers and laminating them on a current collector. Next, the electrode current collector 60 is laminated in contact with the electrode layer 10 of the power generation layer 50, and the counter electrode current collector 70 is laminated in contact with the counter electrode layer 20 of the power generation layer 50. A plurality of battery cells 80 are fabricated, each being the power generation layer 50 having the current correctors laminated thereon. These battery cells 80 are laminated in such a manner as to be electrically series-connected, thereby forming the power-generation element 90. Note that there is no particular limitation as to the method for forming the power-generation element 90. Also, the power-generation element 90 formed in advance may be prepared and used in Step S11.

The first structure 100 used in Step S11 is the first structure 100 fabricated with, for example, the following method. First, the insulating member 150 is disposed or formed on a base material such as a film, the insulating member 150 having an opening portion formed at a position where the component 110 and the contact surface part 130 are to be formed. Next, the contact surface part 130 and the component 110 are disposed in the opening portion of the insulating member 150. The first structure 100 is thus fabricated. Note that there is no particular limitation as to the method for fabricating the first structure 100. For example, the first structure 100 may be formed by laminating the contact surface part 130 and the component 110 and forming the insulating member 150 around them by, e.g., applying resin. Also, the first structure 100 may be fabricated not on the base material such as a film, but on the side surface 90c.

In the method for manufacturing the device 500, next, the power-generation element 90 and the first structure 100 are covered by the second structure 200, and the power-generation element 90 and the first structure 100 are pressurized with the second structure 200 interposed in between (Step S12). The device 500 according to the present embodiment is thus manufactured.

Specifically, as shown in FIG. 3A, the first member 210 is disposed at the first main surface 90a side of the power-generation element 90, and the second member 220 is disposed at the second main surface 90b side of the power-generation element 90. As a result, the first main surface 90a and the first structure 100 are covered by the first member 210, and the second main surface 90b and the first structure 100 are covered by the second member 220. In other words, the power-generation element 90 and the first structure 100 are sandwiched by the first member 210 and the second member 220 of the second structure 200 from both sides in the z-axis direction. Further, the power-generation element 90, the first structure 100, and the second structure 200 are housed in the exterior body 300 as needed. For example, the power-generation element 90, the first structure 100, and the second structure 200 are sandwiched by a laminated film forming the exterior body 300 from both sides in the z-axis direction.

Next, with the second structure 200 interposed in between, the first main surface 90a and the first structure 100 are pressurized from both sides in the z-axis direction. The pressurization is performed by, for example, vacuum sealing of the laminated film forming the exterior body 300. Thus, when the power-generation element 90, the first structure 100, and the second structure 200 are vacuum sealed, the first main surface 90a and the first structure 100 are, due to a pressure difference, pressurized with the second structure 200 interposed in between. Note that the pressurization may be performed by mechanical press using a flat-pressing machine or the like.

As shown in FIGS. 3A and 3B, the inclined structure 211 is formed at the first member 210, and the inclined structure 221 is formed at the second member 220. In Step S12, the first member 210 covers the first main surface 90a and the first structure 100 with the inclined structure 211 covering the first structure 100 and in contact with the first structure 100. Also, the second member 220 covers the second main surface 90b and the first structure 100 with the inclined structure 221 covering the first structure 100 and in contact with the first structure 100. In Step S12, such a second structure 200 having the first member 210 and the second member 220 is used, and the power-generation element 90 and the first structure 100 are pressurized with the second structure 200 interposed in between. As a result, as shown in FIG. 3A, forces are exerted to the first structure 100, from the inclined structure 211 and the inclined structure 221 toward the side surface 90c. Thus, when the power-generation element 90 and the first structure 100 are pressurized with the second structure 200 interposed in between as shown in FIG. 3B, the inclined structure 211 and the inclined structure 221 can press the first structure 100 against the side surface 90c. The side surface 90c and the first structure 100 are thus brought into contact or joined sufficiently, and the component 110 and one or more battery cells 80 can be electrochemically connected at the side surface 90c with the contact surface part 130 interposed in between. As a result, the device 500 including the power-generation element 90 and the component 110 electrochemically connected to the power-generation element 90 is obtained. Especially because the surface 100a and the surface 100b are inclined in correspondence to the inclines of the inclined structure 211 and the inclined structure 221, the pressurizing forces from both sides in the z-axis direction are easily converted into forces for pressing the first structure 100 against the side surface 90c. Also, the layers of the power-generation element 90 are compressed by the pressurization, which enables the power-generation element 90 to have higher battery characteristics.

In this way, in the method for manufacturing the device 500, the inclined structure 211 and the inclined structure 221 press the first structure 100 against the side surface 90c, allowing the first structure 100 to be in contact with or joined with the side surface 90c sufficiently. As a result, a favorable connection state can be formed at the electrochemical connection between the component 110 and the battery cell 80. Thus, the functionality of the component 110 in the device 500 manufactured can be maintained over a long period of time, and the reliability of the device 500 can be enhanced.

Also, for example, the device 500 manufactured is used with the first main surface 90a and the second main surface 90b being pressurized as shown in FIG. 3B (i.e., pressurized from both sides in the z-axis direction) in order for the power-generation element 90 to have improved battery characteristics. In this case, as is similar to the above, the forces pressurizing the first main surface 90a and the second main surface 90b are converted into forces pressing the first structure 100 against the side surface 90c by the inclined structure 211 and the inclined structure 221. As a result, the contact between the side surface 90c and the first structure 100 is maintained more easily. Thus, a favorable connection state is maintained at the electrochemical connection between the component 110 and the battery cell 80 even if impact, vibration, or the like is received from the outside, and thus, the functionality of the component 110 is maintained over a long period of time. Thus, the reliability of the device 500 can be enhanced.

For example, in a case where the power-generation element 90, the first structure 100, and the second structure 200 are sealed by the exterior body 300 under reduced pressure, the forces pressurizing the power-generation element 90, the first structure 100, and the second structure 200 from both sides in the z-axis direction are maintained. Note that even if the device 500 does not include the exterior body 300, the above-described advantageous effects can be offered when the device 500 is used in a pressurized environment.

Also, even in a state where the above-described pressurization is not performed, the presence of the inclined structure 211 and the inclined structure 221 helps prevent the first structure 100 from moving in a direction away from the side surface 90c and allows the component 110 and the battery cell 80 to stay connected. Thus, the reliability of the device 500 can be enhanced.

Also, in the device 500, because the battery cell 80 and the component 110 are electrochemically connected at the side surface 90c of the power-generation element 90, the electrochemical connection between the battery cell 80 and the component 110 is completed within the first structure 100, which enables the device 500 to be compact.

### Embodiment 2

Next, Embodiment 2 is described. In Embodiment 2, an example where the component is a reference electrode is described. The following description of Embodiment 2 focuses mainly on differences from Embodiment 1, omitting or simplifying descriptions of commonalities.

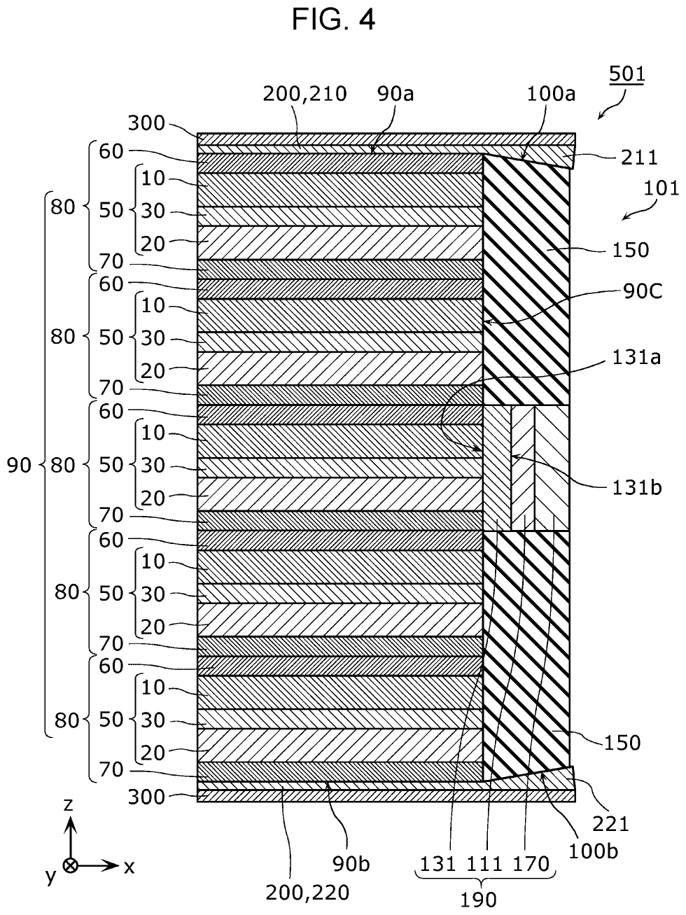

FIG. 4 is a sectional view showing a schematic configuration of a device 501 according to the present embodiment.

As shown in FIG. 4, the device 501 is different from the device 500 according to Embodiment 1 in including a first structure 101 in place of the first structure 100.

For example, the first structure 101 has the same shape as the first structure 100 according to Embodiment 1. The first structure 101 differs from the first structure 100 according to Embodiment 1 in having a reference electrode 111 as a component in place of the component 110, having a second solid electrolyte layer 131 as the contact surface part in place of the contact surface part 130, and additionally having a reference electrode current collector 170. The reference electrode 111 is, for example, a reference electrode used in the three-electrode measurement method. FIG. 4 shows a section cut in the z-axis direction at a position passing through the reference electrode 111 and the power-generation element 90.

The first structure 101 has a reference electrode section 190 having the reference electrode 111, the second solid electrolyte layer 131, and the reference electrode current collector 170 and the insulating member 150. The second solid electrolyte layer 131, the reference electrode 111, and the reference electrode current collector 170 are disposed and arranged in this order along a normal to the side surface 90c in a direction away from the side surface 90c.

The second solid electrolyte layer 131 is located between the reference electrode 111 and the power-generation element 90. The second solid electrolyte layer 131 has a main surface 131a and a main surface 131b opposite to the main surface 131a. The side surface 90c, the main surface 131a, and the main surface 131b are, for example, parallel to one another.

The second solid electrolyte layer 131 is, at the side surface 90c, in contact with the power generation layer 50 in such a manner as not to be in contact with two or more of the plurality of power generation layers 50. Thus, at the side surface 90c, the second solid electrolyte layer 131 is in contact with only one of the plurality of power generation layer 50. Specifically, the main surface 131a of the second solid electrolyte layer 131 is in contact with the side surface of one power generation layer 50. The main surface 131a is in contact with at least part of the side surfaces of the electrode layer 10, the counter electrode layer 20, and the first solid electrolyte layer 30 constituting the one power generation layer 50, the side surfaces being on the first structure 101 side. Note that the main surface 131a only needs to be in contact with at least one of the side surfaces of the electrode layer 10, the counter electrode layer 20, and the first solid electrolyte layer 30 constituting the one power generation layer 50. Among these, the main surface 131a may be in contact with the first solid electrolyte layer 30, and this enables stable measurement using the three-electrode measurement method.

Also, the main surface 131a may further be in contact with at least one of the electrode current collector 60 or the counter electrode current collector 70 in contact with the one power generation layer 50. The longer the length of the main surface 131a in the lamination direction of the power-generation element 90, the higher the mechanical strength. In the lamination direction of the power-generation element 90, the length of the main surface 131a is, for example, equal to or longer than the length of the side surface of the power generation layer 50. The main surface 131a may be in contact with the electrode current collector 60 and the counter electrode current collector 70 disposed between the power generation layers 50 located adjacent to the one power generation layer 50 as long as the main surface 131a is not in contact with these two adjacent power generation layers 50. Note that if the plurality of battery cells 80 are laminated in a parallel-circuit manner in the power-generation element 90, the main surface 131a may be in contact with two or more power generation layers 50.

A material similar to one for the first solid electrolyte layer 30 may be used as a material for forming the second solid electrolyte layer 131. Also, the same material or different materials may be used for the first solid electrolyte layer 30 and the second solid electrolyte layer 131. A single type of solid electrolyte or two or more types of solid electrolyte may be used for the second solid electrolyte layer 131.

Also, the thickness of the second solid electrolyte layer 131 is, for example, 10 μm or greater and 10 mm or smaller. The thickness of the second solid electrolyte layer 131 is, for example, greater than that of the first solid electrolyte layer 30.

The reference electrode 111 faces the side surface 90c with the second solid electrolyte layer 131 in between and is in contact with the second solid electrolyte layer 131. Specifically, the reference electrode 111 is in contact with the main surface 131b of the second solid electrolyte layer 131. This allows the reference electrode 111 to be ion-conductively connected to the electrode layer 10 and the counter electrode layer 20 with the second solid electrolyte layer 131 interposed in between, and therefore, the reference electrode 111 can be used to measure the electrical characteristics of the electrode layer 10 and the counter electrode layer 20. The reference electrode 111 is, for example, in contact with the entire main surface 131b, but may be in contact with part of the region of the main surface 131b. In a case where the reference electrode 111 is in contact with part of the region of the main surface 131b, for example, the reference electrode 111 is located inward of the outer edge of the main surface 131b in a plan view of the main surface 131b. This makes it hard for the reference electrode 111 and the power-generation element 90 to come into contact, which helps prevent short-circuit between the reference electrode 111 and the power-generation element 90.

There is no particular limitation as to the material used for the reference electrode 111 as long as it exhibits an equilibrium potential when in electrochemical contact with the second solid electrolyte layer 131. The reference electrode 111 contains, for example, at least one of metal lithium, a lithium alloy, or a lithium compound. From the perspective of measurement accuracy, a material with small fluctuations of equilibrium potential may be used as the material for the reference electrode 111. Examples of the material with small fluctuations of equilibrium potential include metal lithium, a lithium alloy such as In—Li, and a lithium compound such as Li₄Ti₅O₁₂.

The reference electrode current collector 170 is located on the opposite side of the reference electrode 111 from the second solid electrolyte layer 131 and is in contact with the reference electrode 111. For example, the reference electrode current collector 170 covers the entire surface of the reference electrode 111 which is opposite from the second solid electrolyte layer 131 side. Note that there is no particular limitation as to the position at which the reference electrode current collector 170 is in contact with the reference electrode 111, and the reference electrode current collector 170 may be in contact with any surfaces of the reference electrode 111 as long as it is not the surface in contact with the second solid electrolyte layer 131.

For example, a terminal or the like (not shown) for measuring the electrical characteristics is connected to the surface of the reference electrode current collector 170 which is opposite from the reference electrode 111 side. Note that the reference electrode section 190 does not have to have the reference electrode current collector 170, and for example, electrical characteristics may be measured by bringing an external terminal or the like into direct contact with the reference electrode 111.

Examples of a material for the reference electrode current collector 170 include highly-conductive metal materials, such as copper, aluminum, nickel, iron, stainless steel, platinum, or gold, alloys of two or more of these metal materials, or materials plated with any of these metal materials.

The thickness of the reference electrode current collector 170 is, for example, 1 μm or greater and 20 mm or smaller. Depending on the shape of the first structure 101, the thickness of the reference electrode current collector 170 may be 20 mm or greater.

In a plan view of the side surface 90c, the second solid electrolyte layer 131, the reference electrode 111, and the reference electrode current collector 170 are, for example, circular, rectangular, polygonal, or the like in shape.

In the device 501, the insulating member 150 is located between the reference electrode 111 and the first member 210 and between the reference electrode 111 and the second member 220. Also, the insulating member 150 is located between the second solid electrolyte layer 131 and the first member 210 and between the second solid electrolyte layer 131 and the second member 220. Also, the insulating member 150 is located between the reference electrode current collector 170 and the first member 210 and between the reference electrode current collector 170 and the second member 220. In the device 501, for example, in a plan view of the side surface 90c, the insulating member 150 surrounds the reference electrode section 190.

The height of the insulating member 150 from the side surface 90c is, for example, the same as that of the reference electrode section 190 from the side surface 90c. The height of the insulating member 150 from the side surface 90c may be higher than that of the reference electrode section 190 from the side surface 90c or may be lower than that of the reference electrode section 190 from the side surface 90c. For example, the insulating member 150 may be disposed in such a manner as to surround only the second solid electrolyte layer 131 and the reference electrode 111 of the reference electrode section 190 and not to surround the reference electrode current collector 170.

Because the first structure 101 in the device 501 thus has the reference electrode section 190, at least one of the electric characteristics of the electrode layer 10 and the counter electrode layer 20, such as the electrode potential, can be measured easily.

The device 501, like the device 500, has the second structure 200 provided with the inclined structure 211 and the inclined structure 221 of the second structure 200; thus, when the device 501 is used while being pressurized from both sides in the z-axis direction, the contact between the side surface 90c and the first structure 101 is maintained more easily. Specifically, the contact between the power generation layer 50 and the second solid electrolyte layer 131 ensures ion-conductive connection. Thus, electrochemical measurement can be performed stably over a long period of time using the reference electrode 111 with the three-electrode measurement method, and the reliability of the device 501 can be enhanced. For example, the reference electrode 111 can be used to perform stable measurement of potentials such as electrode potentials.

Also, even in a case where the above pressurization is not performed, the presence of the inclined structure 211 and the inclined structure 221 helps prevent the first structure 101 from moving in a direction away from the side surface 90c, allowing the reference electrode 111 and the battery cell 80 to stay connected. Thus, the reliability of the device 501 can be enhanced.

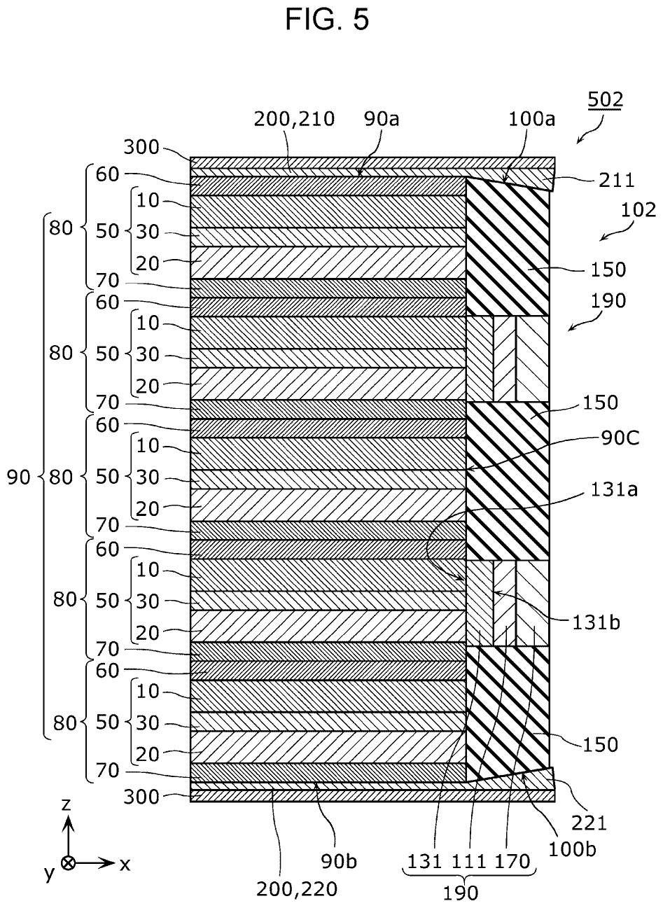

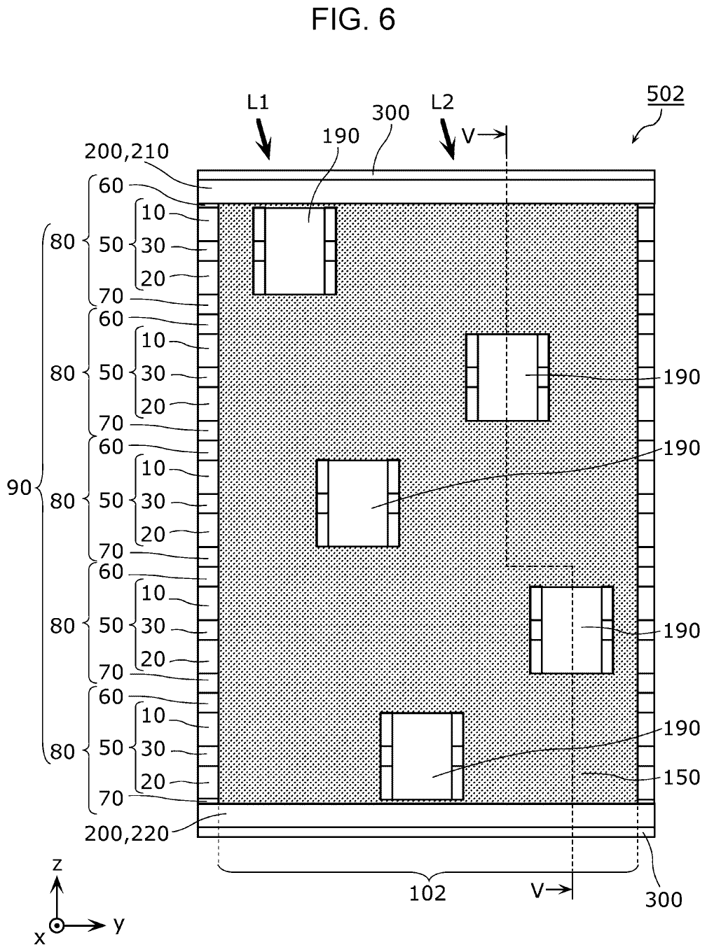

Note that in the device 501, the first structure 101 may have a plurality of reference electrode sections 190. Here, an example of a device including a plurality of reference electrode sections 190 is described. FIG. 5 is a sectional view showing a schematic diagram of a device 502 according to a modification of Embodiment 2. FIG. 6 is a side view showing a schematic configuration of the device 502 according to the modification of Embodiment 2. Note that FIG. 5 shows a section taken along the line V-V in FIG. 6. Also, although the insulating member 150 has a dotted pattern in FIG. 6 to clarify the region where the insulating member 150 is formed, this is not intended to mean that the insulating member 150 actually has a dotted pattern.

As shown in FIGS. 5 and 6, the device 502 differs from the device 501 according to Embodiment 2 in including a first structure 102 in place of the first structure 101.

The first structure 102 has a plurality of reference electrode sections 190. The number of reference electrode sections 190 is not limited to a particular number, but for example, is the same as the number of power generation layers 50 (i.e., the battery cells 80). For example, a single reference electrode section 190 is provided for a single power generation layer 50. For example, in order to measure the electric characteristics of the electrode layer 10 and the counter electrode layer 20 of the power generation layer 50, at least one reference electrode section 190 is provided for every one of the plurality of power generation layers 50. Then, the electric characteristics, such as potential behavior, of the electrode layer 10 and the counter electrode layer 20 can be measured independently for each of the plurality of battery cells 80. Note that the plurality of power generation layers 50 may include a power generation layer 50 provided with no reference electrode section 190.

The insulating member 150 is disposed between the plurality of reference electrode sections 190. As shown in FIG. 6, in a plan view of the side surface 90c, the plurality of reference electrode sections 190 are each surrounded by the insulating member 150. In a plan view of the side surface 90c, the reference electrode section 190 may be uncovered by the insulating member 150 in a given direction.

The plurality of reference electrode sections 190 include two reference electrode sections 190 in contact with respective adjacent ones of the plurality of power generation layers 50. These two reference electrode sections 190 do not overlap when seen in the lamination direction of the power-generation element 90. This allows the interval between the two reference electrode sections 190 to be longer, which allows the two reference electrode sections 190 not to be in contact with each other. Thus, the reliability of the device 502 can be improved even more.

Also, as shown in FIG. 6, all the plurality of reference electrode sections 190 provided at the side surface 90c each have a portion not overlapping with any of the other reference electrode sections 190 when seen in the lamination direction of the power-generation element 90. Thus, the plurality of reference electrode sections 190 have, for example, a portion overlapping only with the insulating member 150 of the first structure 102 when seen in the lamination direction of the power-generation element 90. Thus, even if a conductive member or the like is extended from each reference electrode section 190 in the lamination direction along the surface of the insulating member 150, the conductive member or the like does not bump into the other reference electrode sections 190, which can simplify the structure of a connection portion for electrical connection with each reference electrode section 190. For example, current can be extracted from an upper end portion or a lower end portion of the device 502 by extending a conductive member or the like from each reference electrode section 190 in the lamination direction. In this case, it is also possible to mount the device 502 on a wiring board or the like and connect the conductive member or the like, and the electrical characteristics of the electrode layer 10 and the counter electrode layer 20 can be measured easily.

Also, in a plan view of the side surface 90c, the plurality of reference electrode sections 190 are disposed in a plurality of lines L1, L2 extending in a direction not orthogonal to the lamination direction of the power-generation element 90. The direction in which the plurality of lines L1, L2 extend is inclined relative to the lamination direction. Thus, the plurality of reference electrode sections 190 can be disposed such that each of the plurality of reference electrode sections 190 has a portion not overlapping with any of the other reference electrode sections 190 when seen in the lamination direction of the power-generation element 90. Note that the plurality of reference electrode sections 190 may be disposed in a single line extending in a direction inclined relative to the lamination direction.

Note that there is no particular limitation as to how the plurality of reference electrode sections 190 are disposed in a plan view of the side surface 90c as long as they are disposed such that the second solid electrolyte layers 131 of the respective reference electrode sections 190 are not in contact with one another. For example, the plurality of reference electrode sections 190 may be disposed in a line or may be disposed randomly.

Also, although each of the plurality of reference electrode sections 190 has an individual reference electrode current collector 170, the present disclosure is not limited to this. A single reference electrode current collector 170 may be provided across two or more of the plurality of reference electrode sections 190. In other words, these two or more reference electrode sections 190 may share the single reference electrode current collector 170. This can simplify the structure of the first structure 102 and also increase the mechanical strength of the first structure 102.

Also, although the reference electrode 111 is used as the component in the present modification, a component other than the reference electrode 111, such as an electric circuit, may be used. For example, the component 110 and the contact surface part 130 according to Embodiment 1 may be disposed in the layout of the reference electrode sections 190 shown in FIG. 6.

### Embodiment 3

Next, Embodiment 3 is described. In an example described in Embodiment 3, a first structure includes an electric circuit and terminals connected to the electric circuit. The following description of Embodiment 3 focuses mainly on differences from Embodiments 1 and 2, omitting or simplifying descriptions of commonalities.

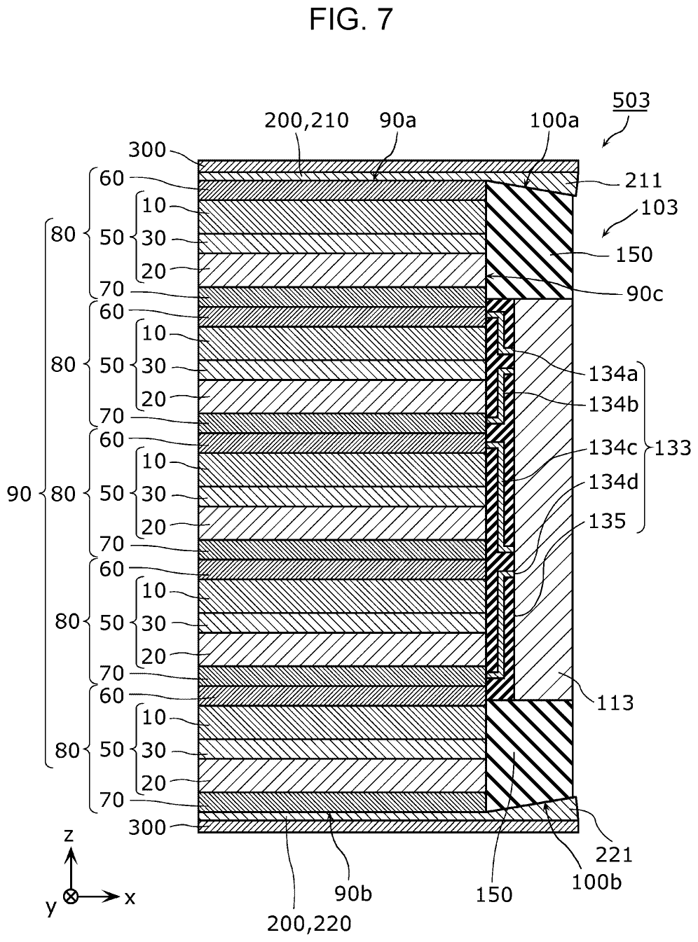

FIG. 7 is a sectional view showing a schematic configuration of a device 503 according to the present embodiment.

As shown in FIG. 7, the device 503 differs from the device 500 according to Embodiment 1 in including a first structure 103 in place of the first structure 100.

For example, the first structure 103 has the same shape as the first structure 100 according to Embodiment 1. The first structure 103 differs from the first structure 100 according to Embodiment 1 in having an electric circuit 113 as a component in place of the component 110 and having a contact surface part 133 in place of the contact surface part 130. The electric circuit 113 is, for example, the battery information measurement circuit, the battery control circuit, the battery management circuit, or the like described above. The electric circuit 113 may include a single type of circuit or two or more types of circuit. Also, the electric circuit 113 may include a plurality of circuits of the same type.

The contact surface part 133 includes terminals 134a, 134b, 134c, 134d and an insulating layer 135. The terminals 134a, 134b, 134c, 134d are terminals for supplying power from at least some of the plurality of battery cells 80 to the electric circuit 113. The electric circuit 113 functions by being supplied with power from the battery cell 80 via the terminals 134a, 134b, 134c, 134d. For example, the terminals 134a and 134b and the terminals 134c and 134d are each a pair of terminals connected in correspondence to the electrode layer 10 and the counter electrode layer 20 of the battery cell 80. In this way, the contact surface part 133 may include a plurality of pairs of terminals.

The terminals 134a, 134b, 134c, 134d connect the side surface 90c and the electric circuit 113. The terminals 134a, 134b, 134c, 134d are, for example, embedded in the insulating layer 135. Specifically, one ends of the terminals 134a, 134b, 134c, 134d are in contact with the battery cells 80 at the side surface 90c. The other ends of the terminals 134a, 134b, 134c, 134d are in contact with the electric circuit 113. The battery cells 80 and the electric circuit 113 are thus connected electron-conductively (in other words, electrically). In the example shown in FIG. 7, the terminal 134a and the terminal 134c are in contact with the electrode current collectors 60 and are connected to the electrode layers 10 electron-conductively via the electrode current collectors 60. Also, the terminal 134b and the terminal 134d are in contact with the counter electrode current collectors 70 and are connected to the counter electrode layers 20 electron-conductively via the counter electrode current collectors 70. The terminal 134a and the terminal 134b thus can supply the electric circuit 113 with voltage from a single battery cell 80. Also, the terminal 134c and the terminal 134d can supply the electric circuit 113 with voltage from two series-connected battery cells 80. Also, the terminal 134a and the terminal 134d may supply the electric circuit 113 with voltage from three series-connected battery cells 80. Note that the terminals 134a, 134b, 134c, 134d may be directly connected to the electrode layers 10 or the counter electrode layers 20.

The terminals 134a, 134b, 134c, 134d are formed using, for example, metal, or may be formed using a conductive resin. In a case where a conductive resin is used, for example, the terminals are formed by applying a conductive resin as a material for the terminals to desired positions on the side surface 90c.

Note that there is no particular limitation as to how the terminals of the contact surface part 133 and the battery cells 80 are connected, and the terminals are connected at given positions depending on the purpose. Also, although the electric circuit 113 is electron-conductively connected to some of the plurality of battery cells 80 via the terminals in the example in FIG. 7, all the plurality of battery cells 80 and the terminals may have connection. Also, the electric circuit 113 may have electron-conductive connection to the first main surface 90a or the second main surface 90b of the power-generation element 90.

Also, the first structure 103 may include a plurality of electric circuits 113. In this case, the device may be designed such that, for example, with regards to the terminals of the contact surface part 133 that are connected in correspondence to the plurality of electric circuits 113, one ends of the terminals are disposed at an interval of the thickness of a desired number of battery cells 80. This enables a configuration where, even if the side surface 90c and the contact surface part 133 are displaced in position a little, any of the electric circuits 113 has electron-conductive connection to the electrode layer 10 and the counter electrode layer 20. Thus, even if the side surface 90c and the contact surface part 133 are displaced in position a little, the electric circuit 113 can fulfill its functionality, and thus, manufacturing of the device 503 can be facilitated.

The insulating layer 135 is located in between the terminals 134a, 134b, 134c, 134d and insulates the terminals 134a, 134b, 134c, 134d from one another. For example, at the side surface 90c, the insulating layer 135 covers the side surfaces of the electrode layers 10, the first solid electrolyte layers 30, and the counter electrode layers 20 and are in contact with the electrode layers 10, the first solid electrolyte layers 30, and the counter electrode layers 20.

The insulating layer 135 is formed using an insulating material with an electrically insulating property. For example, the insulating layer 135 is formed using a resin as the insulating material. Note that the insulating layer 135 may be formed integrally with the insulating member 150.

Because the device 503, like the device 500, has the second structure 200 provided with the inclined structure 211 and the inclined structure 221, when the device is used while being pressurized from both sides in the z-axis direction, the contact between the side surface 90c and the first structure 103 is maintained more easily. Specifically, the contact between the battery cell 80 and the terminals 134a, 134b, 134c, 134d ensures electron-conductive connection. Thus, the electric circuit 113 can be supplied with power from the battery cells 80 and function over a long period of time, and the reliability of the device 503 can thus be enhanced.

Also, even if the above-described pressurization is not performed, the presence of the inclined structure 211 and the inclined structure 221 helps prevent the first structure 103 from moving in a direction away from the side surface 90c and allows the electron-conductive connection to be maintained between the electric circuit 113 and the battery cell 80. Thus, the reliability of the device 503 can be enhanced.

### Other Embodiments

The device according to the present disclosure has thus been described based on the embodiments and modification, but the present disclosure is not limited to these embodiments and modification. The scope of the present disclosure also includes modes obtained by applying various modifications conceived of by those skilled in the art to the embodiments or modification or other modes built by combining some of the constituents in the embodiments and modification, unless such modes depart from the gist of the present disclosure.

For example, although the power-generation element 90 is a solid-state battery or an all-solid-state battery in the embodiments and modification described above, the present disclosure is not limited to this. The power-generation element 90 may be a liquid battery. In this case, for example, the device is configured such that a separator is provided in place of the first solid electrolyte layer 30, and an electrolyte solution fills between the electrode layer 10 and the counter electrode layer 20.

Also, for example, although the first structures 100 to 103 have the insulating member 150 in the embodiments and modification described above, the present disclosure is not limited to this. The first structures 100 to 103 do not have to have the insulating member 150 and may be determined in their shape by a constituent other than the insulating member 150.

Also, for example, although a single first structure is in contact with only the side surface 90c out of the side surfaces of the power-generation element 90 in the embodiments and modification described above, the present disclosure is not limited to this. For example, a device may include a plurality of first structures, and the plurality of first structures are in contact with the side surface 90c and a side surface of the power-generation element 90 other than the side surface 90c. Also, the plurality of first structures may be in contact with different regions on the side surface 90c. In this case, the plurality of first structures may all have the same structure or may have different structures from one another.

Also, for example, although the plurality of battery cells 80 in the power-generation element 90 are electrically series- or parallel-connected in the embodiments and modification described above, the present disclosure is not limited to this. In the power-generation element 90, the plurality of battery cells 80 may be connected using series-connection and parallel-connection in combination.

Also, the embodiments and modification described above can be subjected to various kinds of change, replacement, addition, omission, and the like without departing from the scope of claims and a scope equivalent thereto.

The device according to the present disclosure may be used for various purposes, such as an electronic device, an electric appliance, or an electric vehicle.

What is claimed is:

1. A device comprising:
a power-generation element including at least one battery cell and having a first main surface, a second main surface opposite to the first main surface, and a side surface connecting the first main surface and the second main surface;
a first structure being in contact with the side surface and having a component electrochemically connected to one or more of the at least one battery cell at the side surface; and
a second structure having a first member which is located near the first main surface of the power-generation element and which covers the first main surface and the first structure, wherein
the first member of the second structure has, at a region covering the first structure, an inclined structure which becomes progressively thicker with distance from the side surface.

2. The device according to claim 1, wherein
a surface of the first member which is covered by the first structure is inclined relative to the first main surface such that the first structure becomes progressively smaller with distance from the side surface.

3. The device according to claim 1, wherein
the at least one battery cell includes an electrode layer, a counter electrode layer, and a first solid electrolyte layer disposed between the electrode layer and the counter electrode layer.

4. The device according to claim 3, wherein
the first structure further has a second solid electrolyte layer which is disposed between the component and the side surface and is in contact with at least one of the electrode layer, the counter electrode layer, or the first solid electrolyte layer at the side surface, and
the component is a reference electrode.

5. The device according to claim 1, wherein
the first structure has a terminal that connects the side surface and the component.

6. The device according to claim 1, wherein
the second structure contains metal.

7. The device according to claim 1, wherein
the second structure contains resin.

8. The device according to claim 1, wherein
the first structure further has an insulating member which is located between the component and the first member and which covers the side surface.

9. The device according to claim 1, wherein
the at least one battery cell is a plurality of battery cells, and
the plurality of battery cells are laminated.

10. The device according to claim 9, wherein
the component is electrochemically connected to some of the plurality of battery cells.

11. The device according to claim 1, wherein
the second structure further has a second member which is located near the second main surface of the power-generation element and which covers the second main surface and the first structure, and
the second member of the second structure has, at a region covering the first structure, an inclined structure which becomes progressively thicker with distance from the side surface.

12. The device according to claim 11, wherein
a surface of the first structure which is covered by the second member is inclined relative to the second main surface such that the first structure becomes progressively smaller with distance from the side surface.

13. A method for manufacturing a device including a power-generation element including at least one battery cell and having a first main surface, a second main surface opposite to the first main surface, and a side surface connecting the first main surface and the second main surface and a component electrochemically connected to one or more of the at least one battery cell, the method comprising:
disposing a first structure including the component in such a manner as to cover the side surface and
with the first main surface and the first structure being covered by a first member of a second structure, pressurizing the power-generation element and the first structure with the second structure interposed in between, wherein
in the pressurizing of the power-generation element and the first structure, using the second structure having the first member having an inclined structure which is formed at a region covering the first structure and which becomes progressively thicker with distance from the side surface, the power-generation element and the first structure are pressurized with the second structure interposed in between to press the first structure against the side surface with the inclined structure.
